(19) United States
(12) Patent Application Publication
(10) Pub. No.: US 2025/0287874 A1
(43) Pub. Date: Sep. 18, 2025

(54) Method and Control Unit for Operating an Agricultural Harvester, and Agricultural Harvester

(71) Applicant: CLAAS Saulgau GmbH, 88348 Bad Saulgau (DE)

(72) Inventors: Martin Ober, D-78736 Trichtingen (DE); Markus Zieglschmid, Sigmaringendorf (DE); Matthias Berger, Wolpertswende (DE)

(21) Appl. No.: 19/076,769

(22) Filed: Mar. 11, 2025

(30) Foreign Application Priority Data
Mar. 14, 2024 (DE) 102024107226.1

(51) Int. Cl. A01D 41/14

(52) U.S. Cl. CPC A01D 41/141

(57) ABSTRACT

Method for operating an agricultural harvester (1), wherein the agricultural harvester (1) has a plurality of mowers (3, 4, 5) for mowing crop, comprising at least the following steps: monitoring the operation of the mowers (3, 4, 5), detecting an overload situation at at least one of the mowers (3, 4, 5) depending on the monitoring, lifting out the mower (3, 4, 5) for which an overload situation is detected.

The invention relates to a method for operating an agricultural harvester, to a control unit for operating an agricultural harvester, and to an agricultural harvester.

Agricultural harvesters having at least one mower are known in practice. An agricultural harvester may therefore have a carrier vehicle and at least one mower coupled to the carrier vehicle. Each mower has mowing members for mowing crop.

DE 10 2005 051 543 A1 discloses an agricultural harvester having a carrier vehicle and three mowers coupled to the carrier vehicle. The mowers can lay down or lay out the cut crop in the form of swath.

It is known in practice that a mower of an agricultural harvester has an overload clutch. If, for example, a mower develops a “blockage”, i.e. blocking of the mowing members by crop, an accumulation of soil or by a foreign object, the overload clutch responds in order to protect the mower from damage. If an overload clutch responds, it is operated under slip. In the case of an overload clutch operated under slip, said overload clutch is subjected to a high thermal load. This may result in thermal damage or even destruction of the overload clutch.

There is a need to protect the overload clutch of a mower from thermal damage or even thermal destruction.

Against this background, the present invention is based on the object of creating a novel method and control unit for operating an agricultural harvester, and an agricultural harvester having such a control unit.

This object is achieved by a method for operating an agricultural harvester according to claim 1.

The control unit according to the invention is defined in claim 7.

The agricultural harvester according to the invention is defined in claim 9.

The method according to the invention comprises at least the following steps: monitoring the operation of the mowers, detecting an overload situation at at least one of the mowers depending on the monitoring, lifting out the mower for which an overload situation is detected.

The method according to the invention allows the overload clutch of a mower to be protected from excessive thermal load or even thermal destruction. If an overload situation at at least one mower is detected, said mower is lifted out or raised. Lifting out of the mower resolves the overload situation and protects the overload clutch from further heat input.

Preferably, in order to monitor the operation of the mowers, rotational speeds of the mowers are monitored, an overload situation at at least one of the mowers being detected depending on the monitoring of the rotational speeds of the mowers. It is particularly preferred to detect an overload situation depending on rotational speeds of the mowers.

Preferably, output-side rotational speeds of the mowers are monitored at least in relation to an overload clutch of the respective mower, an overload situation at at least one of the mowers being detected at least depending on the output-side rotational speed of the respective mower. If output-side rotational speeds of the mowers are monitored in relation to an overload clutch of the respective mower in order to detect an overload situation, the invention can be implemented without further outlay on hardware, since mowers have installed in them rotational speed sensors which sense output-side rotational speeds of the mowers in relation to an overload clutch of the respective mower. Preferably, the rotational speeds of the mowing members are sensed as output-side rotational speeds of the respective mower by sensors.

According to a first variant, the output-side rotational speed of a respective mower is compared with an output-side rotational speed of another mower, wherein, whenever the difference between the output-side rotational speeds of two mowers is greater than a limit value, an overload situation is detected at the mower having the lower rotational speed, in particular at the overload clutch of the respective mower.

According to another variant, drive-side rotational speeds of the mowers are also monitored, an overload situation at a respective mower being detected depending on the output-side rotational speed and the drive-side rotational speed of the respective mower, in particular in such a way that, whenever, at a respective mower, a difference between the output-side rotational speed and the drive-side rotational speed is greater than a limit value, an overload situation of the respective mower is detected.

With these variants, an overload clutch can be protected against thermal overstressing and thermal destruction. The first variant is particularly simple and therefore preferred.

Preferred developments of the invention can be gathered from the dependent claims and the following description. Exemplary embodiments of the invention are explained in more detail, without being limited thereto, on the basis of the drawing, in which:

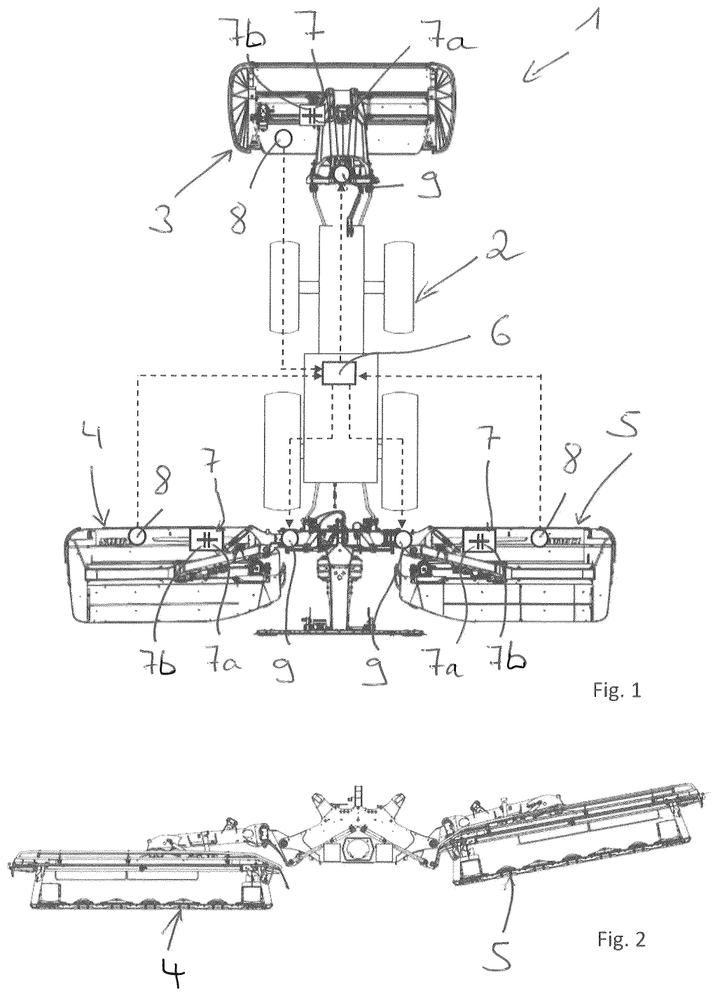

FIG. 1 shows a top view of an agricultural harvester with two rear mowers and a front mower,

FIG. 2 shows a view from the rear of the rear mowers with a lifted out or raised rear mower.

FIG. 1 shows an agricultural harvester 1, which has a carrier vehicle 2 and a plurality of mowers 3, 4 and 5 mounted on the carrier vehicle 2. In FIG. 1, the mower 3 is a front mower, and the mowers 4 and 5 are rear mowers. Each mower 3, 4 and 5 has mowing members (not shown) for mowing crop. The mowing members are also referred to as cutting members.

FIG. 1 furthermore shows that each of the mowers 3, 4 and 5 is assigned an overload clutch 7. If, for example, one of the mowers 3, 4, 5 develops a blockage, i.e. the mowing members are greatly slowed down or blocked by crop, accumulations of soil or by a foreign object, or if the respective mower 3, 4, 5 enters the area of a water hole or an accumulation of soil, the respective overload clutch 7 responds in order to protect the respective mower 3, 4, 5 from mechanical damage.

The respective overload clutch 7 is, for example, a friction clutch having a drive-side clutch half 7a and an output-side clutch half 7b. The drive-side clutch half 7a is supplied with driving power starting from the towing vehicle 2. The output-side clutch half 7b is in contact with the mowing members of the respective mower 3, 4, 5.

If the respective overload clutch 7 responds, slip is present between the respective drive-side clutch half 7a of same and the respective output-side clutch half 7b of same. If, on the other hand, the respective overload clutch 7 is closed, slip is not present between the respective clutch halves 7a, 7b thereof.

Whenever a respective overload clutch 7 has been triggered and accordingly the same slip exists between the respective clutch halves 7a, 7b, frictional heat is generated, as a result of which the respective overload clutch 7 is subjected to a thermal load. The invention is concerned with reducing the thermal load of an overload clutch 7 of a mower 3, 4, 5 and thus with protecting same from thermal damage or even destruction.

According to the invention, the operation of the mowers 3, 4, 5 of the agricultural harvester 1 of FIG. 1 is monitored. Depending on the monitoring of the operation of the mowers 3, 4, 5, an overload situation at at least one of the mowers 3, 4, 5 is detected. If an overload situation at one of the mowers 3, 4, 5 of the agricultural harvester 1 is detected, the respective mower 3, 4, 5, for which the overload situation is detected, is lifted out, i.e. lifted off the ground, preferably by activation of mower hydraulics 9. Preferably, in order to monitor the operation of the mowers 3, 4, 5, the rotational speeds of the mowers 3, 4, 5 are monitored. The detection of an overload situation at a respective mower 3, 4, 5 depends on the monitoring of these rotational speeds.

At least the output-side rotational speed of the mowers 3, 4, 5 in relation to the respective overload clutch 7 is monitored. For this purpose, each of the mowers 3, 4, 5 has installed in it a rotational speed sensor 8 with which the output-side rotational speed of the respective mower 3, 4, 5 in relation to the respective overload clutch 7 can be sensed. An overload situation at at least one of the mowers 3, 4, 5 is then detected at least depending on the monitored output-side rotational speed of the respective mower 3, 4, 5.

In a first variant of the invention, at each of the mowers 3, 4, 5, the respective output-side rotational speed of the respective mower 3, 4, 5 in relation to the overload clutch 7 is sensed. Furthermore, the output-side rotational speed of a respective mower 3, 4, 5 is compared with the output-side rotational speed of another mower 3, 4, 5. The output-side rotational speed of the mower 4 can thus be compared with the output-side rotational speed of the mower 3 and/or with the output-side rotational speed of the mower 5. If the difference between the output-side rotational speed of two mowers is greater than an applicable limit value stored in the control system, an overload situation is detected at the mower having the lower output-side rotational speed. Thus, if the output-side rotational speed of the mower 4 is compared with the output-side rotational speed of the mower 5 and it is determined that the difference between these output-side rotational speeds is greater than a limit value, whenever the output-side rotational speed of the mower 4 is lower than the output-side rotational speed of the mower 5, it is concluded that there is an overload situation at the mower 4.

According to another variant, not only are output-side rotational speeds of the mowers 3, 4, 5 monitored with respect to the respective overload clutch 7, but so too are drive-side rotational speeds of the mowers 3, 4, 5 with respect to the respective overload clutch 7, with an overload situation at a respective mower 3, 4, 5 then being detected depending on the output-side rotational speed and depending on the drive-side rotational speed of the respective mower. If, for example, it is determined at the mower 4 that the difference between a drive-side and output-side rotational speed of the mower 4 is greater than an applicable limit value stored in the control system, it is concluded that the overload clutch 7 of the respective mower 4 is under slip and accordingly there is an overload situation at the respective mower 4. As already explained, whenever an overload situation at a mower 3, 4, 5 is detected, the respective mower 3, 4, 5 is lifted out, i.e. lifted from the ground, preferably by activation of the mower hydraulics 9 of the respective mower 3, 4, 5, in order to eliminate the overload situation.

Lifting out of the mower resolves the overload situation at the respective overload clutch 7 and protects the latter from further heat input and thermal damage or even destruction. In FIG. 2, the mower 5 is lifted out.

The invention also relates to a control unit 6 of the agricultural harvester 1, which control unit is designed to carry out the above-described method automatically in the control system. Thus, the control unit 6 is designed to detect an overload situation at at least one of the mowers 3, 4, 5 during the operation of the agricultural harvester 1 depending on the monitoring of the operation of the mowers 3, 4, 5 and, depending thereon, to output a control variable for the respective mower hydraulics 9 in order to lift out the mower 3, 4, 5 for which an overload situation is detected, automatically up to an applicable height stored in the control unit 6.

The control unit 6 is an electronic control unit which has data interfaces in order to exchange data with the assemblies involved in carrying out the method according to the invention. For example, the control unit 6 receives output-side rotational speeds of the mowers 3, 4, 5 from rotational speed sensors 8 of the mowers 3, 4, 5. The control unit 6 can output a control variable via the data interfaces to the mower 3, 4, 5 for which an overload situation has been detected, namely to an actuator of the respective mower 3, 4, 5, via which the respective mower 3, 4, 5 can be lifted from the ground. The control unit 6 also has a processor for data processing and a memory for data storage.

According to the invention, depending on rotational speeds of the mowers 3, 4, 5 of the agricultural harvester 1, an overload situation at at least one of the mowers 3, 4, 5 is detected and, whenever such an overload situation has been detected, the respective mower 3, 4, 5 is automatically lifted out, and thus lifted off the ground, by activation of the respective mower hydraulics 9. This enables the overload torque at the respective mower 3, 4, 5 to be reduced and the overload clutch 7 to be protected from thermal damage or even destruction.

In the control unit 6, the function according to the invention or the method according to the invention can be activated and deactivated.

The drive-side rotational speeds can be sensed, for example, by further sensors or determined on the basis of a rotational speed of a drive shaft of the carrier vehicle 2. The rotational speed of the drive shaft of the carrier vehicle 2 is preferably transmitted via a data line of an ISOBUS, which is customary in agricultural technology, to the control unit 6 of the harvester 1.

Depending on the equipment of the carrier vehicle 2, the control unit 6 can either directly activate an actuator of a mower 3, 4, 5 to be raised or the control unit 6 of the agricultural harvester 1 sends a signal to a control unit of the carrier vehicle 2 to initiate or request a corresponding control command there.

### LIST OF REFERENCE SIGNS

1 Agricultural harvester
2 Carrier vehicle

### 3 Mower

### 4 Mower

### 5 Mower

6 Control unit
7 Overload clutch
7a Drive-side clutch half
7b Output-side clutch half

### 8 Sensor

9 Mower hydraulics

1. A method for operating an agricultural harvester (1),
wherein the agricultural harvester (1) has a plurality of mowers (3, 4, 5) for mowing crop,
characterized by at least the following steps
monitoring the operation of the mowers (3, 4, 5),
detecting an overload situation at at least one of the mowers (3, 4, 5) depending on the monitoring,
lifting out the mower (3, 4, 5) for which an overload situation is detected.

2. The method according to claim 1, characterized in that
in order to monitor the operation of the mowers (3, 4, 5), rotational speeds of the mowers (3, 4, 5) are monitored,
an overload situation at at least one of the mowers (3, 4, 5) is detected depending on the monitoring of the rotational speeds of the mowers (3, 4, 5).

3. The method according to claim 1, characterized in that
at least output-side rotational speeds of the mowers (3, 4, 5) are monitored,
an overload situation at at least one of the mowers (3, 4, 5) is detected at least depending on the output-side rotational speed of the respective mower (3, 4, 5).

4. The method according to claim 3, characterized in that
the output-side rotational speed of a respective mower (3, 4, 5) is compared with an output-side rotational speed of another mower (3, 4, 5), wherein, whenever the difference between the output-side rotational speeds of two mowers (3, 4, 5) is greater than a limit value, an overload situation is detected at the mower (3, 4, 5) having the lower output-side rotational speed.

5. The method according to claim 3, characterized in that
drive-side rotational speeds of the mowers (3, 4, 5) are also monitored,
an overload situation at the respective mower (3, 4, 5) is detected depending on the output-side rotational speed and the drive-side rotational speed of the respective mower (3, 4, 5).

6. The method according to claim 5, characterized in that
whenever a difference between the output-side rotational speed and the drive-side rotational speed at a respective mower (3, 4, 5) is greater than a limit value, an overload situation of the respective mower (3, 4, 5) is detected.

7. A control unit (6) for an agricultural harvester (1),
wherein the agricultural harvester (1) has a plurality of mowers (3, 4, 5) for mowing crop,
characterized in that
the control unit (6) is designed to detect an overload situation at at least one of the mowers (3, 4, 5) depending on the monitoring of the operation of the mowers (3, 4, 5) and, depending thereon, to output a control variable in order to lift out the mower (3, 4, 5) for which an overload situation is detected.

8. (canceled)

9. An agricultural harvester (1), having mowers (3, 4, 5) and having a control unit (6) according to claim 7.

10. A control unit (6) for an agricultural harvester (1) having a plurality of mowers (3, 4, 5) for mowing a crop, the control unit (6) is designed to detect an overload situation at at least one of the mowers (3, 4, 5) depending on the monitoring of the operation of the mowers (3, 4, 5) and, depending thereon, to output a control variable in order to lift out the mower (3, 4, 5) for which an overload situation is detected, characterized in that the control unit (6) is designed to carry out the method according to claim 1 automatically in the control system
